(19) United States
(12) Patent Application Publication
(10) Pub. No.: US 2026/0280983 A1
(43) Pub. Date: Sep. 17, 2026

(54) METHOD AND APPARATUS FOR PROVIDING AI SERVICE, DEVICE, AND STORAGE MEDIUM

(71) Applicant: BEIJING XIAOMI MOBILE SOFTWARE CO., LTD., Beijing (CN)

(72) Inventors: Dong CHEN, Beijing (CN); Yuze SUN, Beijing (CN)

(73) Assignee: BEIJING XIAOMI MOBILE SOFTWARE CO., LTD., Beijing (CN)

(21) Appl. No.: 18/871,772

(22) PCT Filed: Jun. 13, 2022
(86) PCT No.: PCT/CN2022/098484

§ 371 Date: Dec. 4, 2024

(51) Int. Cl. H04L 41/0833

(52) U.S. Cl. CPC H04L 41/0833

(57) ABSTRACT

The present disclosure provides a method and apparatus for providing AI service, a device, and a storage medium. The method may include: a first core network device receives a first request message from a second core network device, the first request message being used for requesting the first core network device to provide first AI service; the first core network device allocates the first AI service to at least one third core network device according to the first request message; the first core network device obtains a processing result of the first AI service from the at least one third core network device; and the first core network device sends a first response message to the second core network device, the first response message carrying result information of the first AI service obtained on the basis of the processing result.

### CROSS-REFERENCE

The present application is a U.S. national stage of PCT Application No. PCT/CN2022/098484, filed on Jun. 13, 2022, which is incorporated by reference herein by reference in its entirety for all purposes.

### TECHNICAL FIELD

The present disclosure relates to the field of communication technologies, and in particular to a method and apparatus for providing an artificial intelligence (AI) service, a device and a storage medium.

### BACKGROUND

The development of communication networks is accompanied by the continuous integration with AI technologies. It is expected that there will be a large overlap between application scenarios of the sixth generation mobile communication technologies (i.e. 6G) and application scenarios of the AI technologies. AI networks can be deployed in the communication networks to provide AI functions to the communication networks, making the communication networks intelligent.

### SUMMARY

The present disclosure provides a method and apparatus for providing an AI service, a device and a storage medium.

According to a first aspect of the present disclosure, there is provided a method for providing an AI service. The method can be applied to a first core network device in a communication system. The method includes: receiving, by the first core network device, a first request message from a second core network device, wherein the first request message is configured to request the first core network device to provide a first AI service; assigning, by the first core network device, the first AI service to at least one third core network device according to the first request message; obtaining, by the first core network device, a processing result of the first AI service from the at least one third core network device; and sending, by the first core network device, a first response message to the second core network device, wherein result information of the first AI service obtained based on the processing result is carried in the first response message.

According to a second aspect of the present disclosure, there is provided a method for providing an AI service. The method can be applied to a second core network device in a communication system. The method includes: receiving, by the second core network device, a second request message from a terminal, wherein the second request message is configured to request a first AI service; sending, by the second core network device, a first request message to a first core network device, wherein the first request message is configured to request the first core network device to provide the first AI service; receiving, by the second core network device, a first response message from the first core network device, wherein result information of the first AI service is carried in the first response message; and sending, by the second core network device, a second response message to the terminal, wherein the result information of the first AI service is carried in the second response message.

According to a third aspect of the present disclosure, there is provided a method for providing an AI service. The method can be applied to a terminal in a communication system. The method includes: sending, by the terminal, a second request message to a second core network device, wherein the second request message is configured to request a first AI service; and receiving, by the terminal, a second response message from the second core network device, wherein result information of the first AI service is carried in the second response message.

According to a fourth aspect of the present disclosure, there is provided a core network device, including: a memory, configured to store computer executable instructions; and a processor, connected to the memory and configured to execute the computer executable instructions stored on the memory to implement the method according to any one of the first aspect and the second aspect and their implantations.

According to a fifth aspect of the present disclosure, there is provided a terminal, including a memory, configured to store computer executable instructions; and a processor, connected to the memory and configured to execute the computer executable instructions stored on the memory to implement the method according to any one of the third aspect and its implantations.

According to a sixth aspect of the present disclosure, there is provided a computer readable storage medium having computer executable instructions stored thereon; and the computer executable instructions, when executed by a processor in a computer, enable the method according to any one of the first aspect to the third aspect and their implantations to be implemented.

According to a seventh aspect of the present disclosure, there is provided a computer program or a computer program product, and the computer program product, when executed on a computer, causes the computer to implement the method according to any one of the first aspect to the third aspect and their implantations.

It should be understood that the third to seventh aspects of the present disclosure are consistent with the technical solutions of the first to second aspects of the present disclosure, and the beneficial effects achieved by each aspect and the corresponding feasible implementation methods are similar, which will not be repeated.

### BRIEF DESCRIPTION OF THE DRAWINGS

FIG. 1 is a schematic diagram of a service-based interface based architecture in a non-roaming 5G network according to one or more examples of the present disclosure;

FIG. 2 is a schematic flowchart of a method for providing an AI service according to one or more examples of the present disclosure;

FIG. 3 is a schematic flowchart of a method for providing an AI service according to one or more examples of the present disclosure;

FIG. 4 is a schematic flowchart of a method for providing an AI service according to one or more examples of the present disclosure;

FIG. 5 is a schematic flowchart of a method for providing an AI service according to one or more examples of the present disclosure;

FIG. 6 is a schematic structural diagram of an apparatus for providing an AI service according to one or more examples of the present disclosure;

FIG. 7 is a schematic structural diagram of an apparatus for providing an AI service according to one or more examples of the present disclosure;

FIG. 8 is a schematic structural diagram of an apparatus for providing an AI service according to one or more examples of the present disclosure;

FIG. 9 is schematic structural diagram of a communication device according to one or more examples of the present disclosure;

FIG. 10 is schematic structural diagram of a terminal according to one or more examples of the present disclosure;

FIG. 11 is schematic structural diagram of a network device according to one or more examples of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the embodiments of the present disclosure as recited in the appended claims.

The terms used in the embodiments of the present disclosure are merely for the purpose of describing particular embodiments and are not intended to limit the embodiments of the present disclosure. As used in the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms “first”, “second”, “third”, etc. may be used in embodiments of the present disclosure to describe various information, such information should not be limited to these terms. These terms are only used to distinguish the same type of information from each other. For example, without departing from the scope of embodiments of the present disclosure, “first information” may also be referred to as “second information”, and similarly, “the second information” may also be referred to as “the first information”. Depending on the context, the word “if” as used herein can be interpreted as “upon” or “when” or “in response to determination”.

Furthermore, in the description of the embodiments of the present disclosure, “and/or” is only a description of the association relationship of the associated objects, indicating that three relationships may exist. For example, A and/or B can represent: A exists alone, A and B exist at the same time, and B exists alone. In addition, in the description of the embodiments of the present disclosure, “a plurality of” can refer to two or more than two.

The integration of AI technologies and communication technologies is an inevitable trend in the future development of science and technology. On the one hand, the development of the communication technologies requires that communication networks have an increasingly high degree of intelligence. Various stages of the communication networks, such planning, construction, maintenance and optimization, require the use of automated and intelligent technologies to improve their efficiency. On the other hand, the large coverage of the communication networks provides a reliable carrier and channel for the AI technologies. With the support of the communication networks, the AI technologies can be spread everywhere, thereby promoting the development of the AI technologies and the prosperity of the AI industry.

In the related arts, software defined network (SDN) and network functions virtualization (NFV) are often used to enhance the flexibility of the communication networks. However, while the SDN and the NFV enhance the flexibility, they also make architectures of the communication networks more complex. For example, in aspects such as assignment of network resources, transmission paths, and optimization algorithm design, the SDN and the NFV require more factors to be taken into consideration and intelligent technologies to be adopted.

To this end, by integrating the AI technologies into the communication networks, the degree of intelligence of the communication networks can be improved, thereby improving efficiency while controlling costs. However, the architectures of the communication networks were formulated earlier than the application of the AI technologies, and under the current circumstances, network intelligence is achieved by optimizing or transforming traditional network architectures. Therefore, the AI functions basically exist in the communication networks in the form of “plug-ins”. In addition, due to the lack of a unified framework and process for the AI functions in the communication networks, the application scenarios of individual AI functions are “fragmented”, and the research and development of individual AI functions belongs to “chimney-style” research and development. This results in AI functions being able to be simply superimposed on the existing network architecture and process, and it is difficult to achieve collaborative processing between the AI functions.

Therefore, how to schedule and coordinate the AI functions in AI networks is an urgent problem that needs to be solved.

In order to solve the above problems, examples of the present disclosure provide a method for providing an AI service.

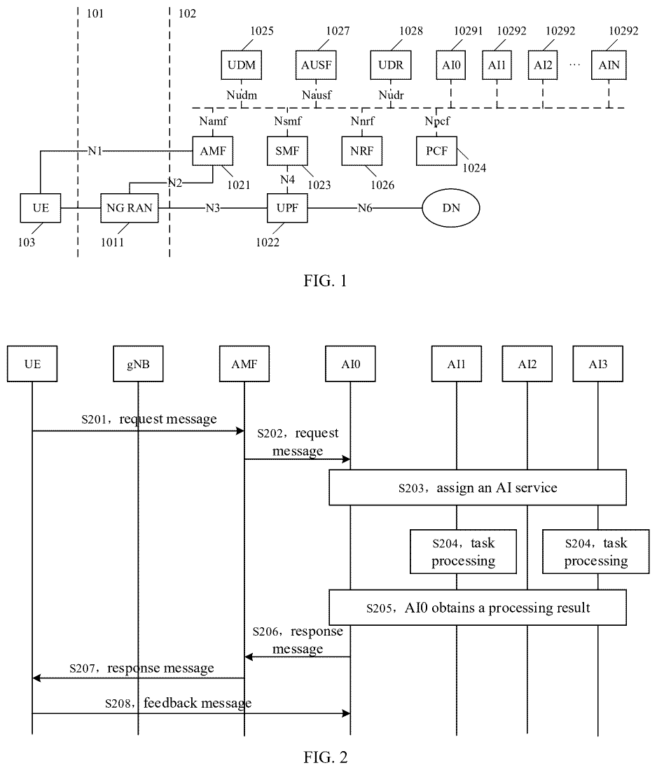

Examples of the present disclosure provide a communication system to implement the method for providing the AI service in the embodiments of the present disclosure. The communication system being a fifth generation mobile communication technology (i.e., 5G) communication system is taken as an example for illustration. FIG. 1 is a schematic diagram of a service-based interface based architecture in a non-roaming 5G network according to an example of the present disclosure. Referring to FIG. 1, a communication system 100 may include a 5G access network (AN) 101 and a 5G core network (5GC) 102. The 5G access network 101 may include a next generation radio access network (NG RAN) 1011, and the NG RAN 1011 communicates with a terminal 103 via a Uu interface. The 5G core network 102 may include: an access and mobility management function (AMF) 1021, a user plane function (UPF) 1022, a session management function (SMF) 1023, a policy control function (PCF) 1024, a unified data management (UDM) 1025, a network repository function (NRF) 1026, an authentication server function (AUSF) 1027, a unified data repository function (UDR) 1028, an AI function 1029, etc. In the examples of the present disclosure, the communication system 100 may also include other network elements, which are not specifically limited in the examples of the present disclosure.

In the communication system 100, the terminal 103 can access the 5G core network 102 through the 3rd generation partnership project (3GPP) technologies. Specifically, the terminal 103 can access the 5G core network 102 through a 3GPP access network device.

Here, each network element in the communication system 100 is described. AMF 1021 has access and mobility management functions, and mainly performs mobility management, access authentication/authorization and other functions. In addition, AMF 1021 is also responsible for transmitting user policies between the UE and the PCF. UPF 1022 is a user plane functional entity, which is an interface with a data network and completes user plane (UP) data forwarding, session/flow-level billing statistics, bandwidth limitation and other functions. SMF 1023 has a session management function, and mainly performs session management, PCF-issued control policies, UPF selection, UE Internet protocol (IP) address assignment and other functions. PCF 1024 has a policy control function, and is mainly responsible for policy decisions related to billing policies for sessions and services flows, quality of service (QoS) bandwidth guarantee and policies. UDM 1025 has a unified data management function, and is mainly responsible for managing subscription data, user access authorization and other functions.

The AI function 1029 includes an AI management function 10291 and an AI processing function 10282. The AI management function 10291 has a resource assignment function for the AI service, which is mainly used to perform task division and task assignment for the AI service, and to perform signaling interaction with other network elements. The AI management function 10291 includes AI0. The AI processing function 10292 has an AI calculation function, which is used to process the AI task. The AI processing function 10292 includes a plurality of AI processing functions such as AI1, AI2, . . . , AIN, etc.

Here, interfaces between individual network elements in the communication system 100 are described. Referring to FIG. 1, in the 5G core network 102 of the non-roaming 5G network, individual network elements interact with each other using service-based interfaces. For example, AMF 1021, SMF 1023, PCF 1024, UDM 1205, NRF 1026, AUSF 1027, UDR 1028, and the AI function 1029 interact with each other using service-based interfaces. The service-based interface provided by AMF 1021 to the outside may be Namf. The service-based interface provided by SMF 1023 to the outside may be Nsmf. The service-based interface provided by PCF 1024 to the outside may be Npcf. The service-based interface provided by UDM 1025 to the outside may be Nudm. The service-based interface provided by NRF 1026 to the outside may be Nnrf. The service-based interface provided by ASUF 1027 to the outside may be Nausf. The service-based interface provided by UDR 1028 to the outside may be Nudr. The service-based interface provided by the AI function 1028 to the outside world may be Nai.

In addition, referring to FIG. 1, there are also non service-based interfaces in the 5G core network 102. N1 is an interface between the AMF and the UE, which is independent of access and is used to transmit QoS control rules to the UE. N2 is an interface between the AMF and the RAN, which is used to transmit radio bearer control information from the core network side to the RAN. N3 is a communication interface between the UPF and the NG-RAN. N4 is an interface between the SMF and the UPF, which is used to transmit information between the control plane and the UP, including the issuing of forwarding rules, QoS control rules, traffic statistics rules, etc. from the control plane to the UP and the information reporting by the UP. N6 is an interface between the UPF and a data network (DN).

The terminal may be a terminal with wireless communication function, and may also be called user equipment (UE). The terminal may be deployed on land, including indoor or outdoor, handheld, wearable or vehicle-mounted; it may also be deployed on the water surface (such as ships, etc.); it may also be deployed in the air (such as airplanes, balloons and satellites, etc.). The terminal may be a mobile phone, a Pad, a computer with wireless transceiver function, a virtual reality (VR) terminal, an augmented reality (AR) terminal, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, etc. The terminal may also be a handheld device with wireless communication function, a vehicle-mounted device, a wearable device, a computing device or other processing device connected to a wireless modem, etc. Optionally, the terminal may be called different names in different networks, such as: terminal, access terminal, user unit, user station, mobile station, mobile site, remote station, remote terminal, mobile device, user terminal, terminal, wireless communication device, user agent or user device, cellular phone, cordless phone, session initiation protocol (SIP) phone, wireless local loop (WLL) station, personal digital assistant (PDA), terminal equipment in 5G network or future evolution network, etc.

The access network device may be a device on the access network side for supporting terminals to access the wireless communication system. For example, it may be a next generation NodeB (gNB), a transmission reception point (TRP), a relay node, an access point (AP), etc. in a 5G access technology communication system.

It should be noted that in the communication system 100 shown in FIG. 1, the functions and interfaces of each device are only exemplary, and not all functions of each device are essential when applied in the examples of the present disclosure. All or part of the devices of the core network may be physical entity devices or virtualized devices, which are not limited here. Alternatively, the communication system in the examples of the present disclosure may also include other devices not shown in FIG. 1, which are not limited here.

It should be understood that the relevant description of names of various service-based interfaces in FIG. 1 can refer to the 5G system architecture diagram in the 3GPP TS 23.501 standard, which will not be repeated here.

Based on the communication system shown in FIG. 1, the basic concept of examples of the present disclosure is as follows: after receiving an AI service request of a terminal, an AI management function AI0 divides an AI service into at least one task and assigns the at least one task to at least one of AI processing functions AI1, AI2, . . . , AIN; the AI processing function assigned with the task performs the task processing and sends the processing result to AI0; AI0 then summarizes the processing result and sends the summarized results to the terminal. In the process of assigning the at least one task, AI0 can determine an assignment strategy based on the at least one task divided from the AI service and device information of the AI processing functions AI1, AI2, . . . , AIN.

In an example of the present disclosure, the determination of the assignment strategy can meet the following assumptions or prerequisites: (1) the terminal has completed an initial registration process and accessed to a network; (2) each AI function has completed registration at the NRF function and can access and work normally in a core network architecture; (3) the core network has authenticated each AI function to ensure its secure access; (4) AI0 and AI1, . . . , AIN trust each other and transmit communication information such as the real delay and the energy consumption; (5) the communication quality (including the channel quality and the bandwidth) between each AI function and AI0 is the same; (6) each time AI0 performs the task assignment, individual AI functions jointly complete the total task and are respectively responsible for one of the tasks. Each time the AI service is provided, only some AI functions participate in calculation and communication.

According to examples of the present disclosure, AI0 can establish an optimization model based on the device information of the AI processing functions AI1, AI2, . . . , AIN, and can determine the assignment strategy based on the optimization model. The optimization model includes a constraint condition, an input and an output, and the constraint condition is the constraint on the input and/or output.

In an example of the present disclosure, the purpose of optimization is to minimize a total energy consumption value for completing each task while meeting a delay requirement. In this case, the input may be an indication value that each task is assigned to each AI processing function, the output may be an energy consumption value, and the constraint condition may be that a delay value of the AI service is within a preset delay threshold. The device information may include the energy consumption value and the delay value of each AI processing function. It should be noted that the device information may also include other information, which is not limited in embodiments of the present disclosure.

The delay value of the AI processing function is configured to represent a delay of an AI processing function in processing a task. In an example, the delay value may include a transmission delay and a processing time. The transmission delay is a delay of transmission between AI0 and the AI processing function. The transmission delay may include a downlink delay and an uplink delay. The downlink delay is a delay of downlink transmission from AI0 to the AI processing function. The uplink delay is a delay of uplink transmission from the AI processing function to AI0. The processing time is a time of the AI processing function in processing the task. The processing time may include a calculation time and a waiting time. The calculation time is a time to calculate the task. The waiting time is a time the task waits in queue in the AI processing function.

Correspondingly, for example, the constraint condition may include: the sum of the transmission delay and the processing time of at least one AI processing function processing at least one task is less than a delay threshold, or the sum of the transmission delay and the processing time of the at least one AI processing function processing the at least one task is less than or equal to the delay threshold. For another example, considering that a bandwidth of the downlink transmission is much larger than a bandwidth of the uplink transmission, or a rate of the downlink transmission is much larger than a rate of the uplink transmission, resulting in the downlink delay being much smaller than the uplink delay, the downlink delay can be ignored. In this case, the constraint condition may include: the sum of the uplink delay and the processing time of the at least one AI processing function processing the at least one task is less than the delay threshold, or the sum of the uplink delay and the processing time of the at least one AI processing function processing the at least one task is less than or equal to the delay threshold.

In an example of the present disclosure, for the optimization model, a delay constraint condition is constructed in the following manner.

At least one task obtained by dividing the AI service by AI0 can be represented as T1, T2, . . . , TK. The AI processing function includes AI1, AI2, . . . , AIN. K and N are both positive integers.

The processing time of the i-th AI processing function processing the k-th task among the at least one task can be obtained by the following formula (1):

$${T}_{p \_ ik} = {T}_{c \_ ik} + {T}_{w \_ ik} \qquad ( 1 )$$

where, T_{p_ik} represents the processing time of the i-th AI processing function processing the k-th task; T_{c_ik} represents the calculation time of the i-th AI processing function processing the k-th task; T_{w_ik} represents the waiting time of the i-th AI processing function processing the k-th task. For example, the waiting time may be a queuing time of a workload that has not been processed before the i-th AI processing function processes the k-th task. k is an integer greater than or equal to 1 and less than or equal to K. i is an integer greater than or equal to 1 and less than or equal to N.

Specifically, in an example, the processing time T_{c_ik} can be obtained by the following formula (2):

$${T}_{c \_ ik} = {W}_{ik} / {CLK}_{i} \qquad ( 2 )$$

where, Dᵢₖ represents the amount of calculation resources required for the i-th AI processing function to process the k-th task, for example, a clock cycle; CLKᵢ represents a clock frequency of the i-th AI processing function.

In addition, the transmission delay of the i-th AI processing function processing the k-th task among the at least one task can be obtained by the following formula (3):

$${T}_{t \_ ik} = {T}_{u \_ ik} + {T}_{d \_ ik} \qquad ( 3 )$$

where, T_{t_ik} represents the transmission delay of the i-th AI processing function processing the k-th task; T_{u_ik} represents the uplink delay of the i-th AI processing function processing the k-th task; and T_{d_ik} represents the downlink delay of the i-th AI processing function processing the k-th task.

It should be noted that, as mentioned above, in actual applications, the uplink delay is usually much greater than the downlink delay. Therefore, in an example of the present disclosure, the downlink delay T_{d_ik} can be ignored, and T_{t_ik}=T_{u_ik}.

On the basis of knowing the processing time T_{p_ik} and the transmission time T_{t_ik} of each AI processing function, the total delay of the AI processing functions to complete K tasks can be obtained. In an example, the total delay can be obtained by the following formula (4):

$$T = {T}_{p} + {T}_{t} = {\sum }_{k = 1}^{K} {\sum }_{i = 1}^{N} {T}_{p \_ ik} \times {y}_{ik} + {\sum }_{k = 1}^{K} {\sum }_{i = 1}^{N} {T}_{t \_ ik} \times {y}_{ik} \qquad ( 4 )$$

where, T represents the total delay of the AI processing functions to complete K tasks; Tₚ represents the total processing time of the AI processing functions to complete K tasks; and Tₜ represents the total transmission time of the AI processing functions to complete K tasks. yᵢₖ is a binary variable with a value range of {0, 1}, which is configured to indicate whether the i-th processing function processes the k-th subtask. If yᵢₖ takes the value of 1, it indicates that the i-th processing function processes the k-th subtask, and if yᵢₖ takes the value of 0, it indicates that the i-th processing function does not process the k-th subtask. It can be understood that a set of values of yᵢₖ obtained for all values of i (i.e., 1, 2, . . . , N) is the assignment strategy of the k-th task among the device information of the AI processing functions AI1, AI2, . . . , AIN.

In order to meet the delay constraint of the AI service, the total delay T needs to be within the range of the preset delay threshold Tₜₕ, that is, T≤Tₜₕ. So far, the constraint condition of the optimization model with respect to the delay can be obtained.

In addition, the energy consumption value of the AI processing function is configured to represent an energy consumption of the AI processing function in processing the task. In an example, the energy consumption value may include the transmission energy consumption and a calculation energy consumption. The transmission energy consumption is the energy consumption for transmission between AI0 and the AI processing function. The transmission energy consumption includes the downlink energy consumption and the uplink energy consumption. The downlink energy consumption is the energy consumption for downlink transmission from AI0 to the AI processing function. The uplink energy consumption is the energy consumption for uplink transmission from the AI processing function to AI0. The calculation energy consumption is the energy consumption for the AI processing function to calculate the task.

The transmission energy consumption of the i-th AI processing function processing the k-th task among the at least one task can be obtained by the following formula (5):

$${E}_{t \_ ik} = {E}_{u \_ ik} + {E}_{d \_ ik} \qquad ( 5 )$$

where, E_{t_ik} represents the transmission energy consumption of the i-th AI processing function processing the k-th task; E_{u_ik} represents the uplink energy consumption of the i-th AI processing function processing the k-th task; and E_{d_ik} represents the downlink energy consumption of the i-th AI processing function processing the k-th task.

It should be noted that, in actual applications, the energy consumption of the AI processing function when sending information is typically much greater than the energy consumption when receiving information, that is, the uplink energy consumption is typically much greater than the downlink energy consumption. Therefore, in an example, the downlink energy consumption E_{d_ik} can be ignored, and then E_{t_ik}=E_{u_ik}.

The uplink energy consumption can be obtained by the following formula (6):

$${E}_{u \_ ik =} {p}_{i} \times {N}_{ik} \times {T}_{i} \qquad ( 6 )$$

where, E_{u_ik} represents the uplink energy consumption of the i-th AI processing function sending the processing result of the k-th task to AI0; Pᵢ represents the energy consumption (or called information transmission power) of the i-th AI processing function sending 1 bit of information to AI0; Nᵢₖ represents the amount of information (i.e., the number of bits) of the processing result of the k-th task processed by the i-th AI processing function; and Tᵢ represents the minimum transmission time for the i-th AI processing function to send 1 bit of information to AI0.

In addition, the calculation energy consumption of the AI processing function is related to one or more factors. These factors include but are not limited to: the time complexity and the space complexity of the AI algorithm, the number of parameters of an AI algorithm model, the clock frequency and the operating power of the AI processing function. Combining these factors, the calculation energy consumption of the i-th AI processing function processing the k-th task can be obtained by the following formula (7):

$${E}_{c \_ ik} = {q}_{i} \times {D}_{ik} \qquad ( 7 )$$

where, E_{c_ik} represents the calculation energy consumption of the i-th AI processing function to process the k-th task; qᵢ represents the energy consumption (or called information processing power) of the i-th AI processing function to process 1 bit of information; Dᵢₖ represents the amount of calculation resources required for the i-th AI processing function to process the k-th task, for example, a clock cycle.

On the basis of knowing the calculation energy consumption E_{c_ik} and the transmission energy consumption E_{t_ik} of each AI processing function, the total energy consumption of the AI processing functions to complete K tasks can be obtained. In an example, the total energy consumption can be obtained by the following formula (8):

$$E = {E}_{c} + {E}_{t} = {\sum }_{k = 1}^{K} {\sum }_{i = 1}^{N} {E}_{c \_ ik} \times {y}_{ik} + {\sum }_{k = 1}^{K} {\sum }_{i = 1}^{N} {E}_{t \_ ik} \times {y}_{ik} \qquad ( 8 )$$

where, E represents the total energy consumption of the AI processing function to complete K tasks; Eₜ represents the calculation energy consumption of the AI processing function to complete K tasks; and Eₜ represents the transmission energy consumption of the AI processing function to complete K tasks.

Therefore, an optimization target in the optimization model is min (E), which is used to determine the minimum value of the total energy consumption E of the AI processing function to complete K tasks. So far, the optimization target of the optimization model with respect to the energy consumption can be obtained.

In addition to the above constraint conditions on the delay and the optimization function of the energy consumption, the optimization model can also include constraint conditions for the following situations.

(1) The k-th task is assigned to only one AI processing function. For example, the optimization model may also include the following constraint conditions:

$${\sum }_{i = 0}^{N} {y}_{ik} = 1 \qquad ( 9 )$$

where, yᵢₖ ∈ {0, 1}, i.e., the value of yᵢₖ is 0 or 1; ∇i∈{1, . . . , N}, i.e., the value of i is an integer from 1 to N; Δk∈K, i.e., the value of k is an integer from 1 to K. It can be seen from formula (9) that for one AI processing function, the value of yᵢₖ is 1; for other AI processing functions, the value of yᵢₖ is 0.

(2) Tasks are independent of each other. To this end, it is necessary to consider the predecessor tasks of the k-th task. For example, a list Lₖ can be set to represent a list of predecessor tasks of the k-th task, and a binary variable Zₖ can be used to indicate whether the k-th task has been assigned. A value of Zₖ can be 0 or 1. If the value of Zₖ is 0, it indicates that the k-th task has not been assigned; if the value of Zₖ is 1, it indicates that the k-th task has been assigned. Accordingly, the optimization model can also include the following constraint condition:

$${z}_{k} = {\sum }_{i = 0}^{N} {y}_{ik} and {z}_{k} \leq {z}_{j} \qquad ( 9 )$$

where, ∇k εK; zₖ ∈{0, 1}; ∇j ∈Lₖ, that is, the j-th task belongs to the list Lₖ.

Combining the above constraint conditions and the optimization function, the optimization model can be obtained as follows:

$$Optimization goal : min {\sum }_{k = 1}^{K} {\sum }_{i = 1}^{N} ( {E}_{c \_ ik} \times {y}_{ik} + {E}_{t \_ ik} \times {y}_{ik} ) ;$$

$$Constraint condition : {T}_{p} + {T}_{t} \leq {T}_{th} ;$$

$${\sum }_{i = 0}^{N} {y}_{ik} = 1 , ∀ k ∈ K ;$$

$${y}_{ik} ∈ \{ 0 , 1 \} , ∀ i ∈ \{ 1 , … , N \} , ∀ k ∈ K ;$$

$${z}_{k} = {\sum }_{i = 0}^{N} {y}_{ik} , ∀ k ∈ K ;$$

$${z}_{k} ∈ \{ 0 , 1 \} , ∀ k ∈ K ; and$$

$${z}_{k} \leq {z}_{j} , ∀ j ∈ {L}_{k} , ∀ k ∈ K .$$

So far, the optimization model can be obtained.

It can be understood that the process of finding the optimal solution based on the above optimization model can be implemented using a dynamic programming algorithm. In an example of the present disclosure, since the value ranges of yᵢₖ and zᵢₖ are both {0, 1}, the process of finding the optimal solution based on the above optimization model is essentially an integer programming problem. In an example, the integer programming can be a 0-1 programming.

In an example of the present disclosure, in order to find the optimal solution, one or more methods of a cutting plane method, a branch and bound method, and a simplex method may be used.

In an example, an algorithm consisting of the cutting plane method, the branch and bound method, and the simplex method can be used to find the optimal solution. Specifically, first, AI0 converts an integer variable yᵢₖ (i=∈{1, . . . , N} and k∈K) into a continuous variable y, thereby relaxing the integer programming problem. After that, AI0 uses the simplex method to solve the relaxation problem. When the optimal solution is obtained, AI0 searches for a decimal variable with a decimal value. AI0 adds the linear constraints, so that all integer variables satisfy the constraints, but the decimal variable violates the constraints, thereby cutting off part of the solution set and retaining the integer solution. The above process is repeated to improve the relaxation and make the existing solution set closer to the integer solution. When there is no longer a cutting plane or a complete integer solution is obtained, AI0 determines that the algorithm converges. In the case where no additional cutting planes can be found and the solution obtained is not an integer solution, the algorithm can be recursively performed according to the branch and bound method. The branch and bound method is mainly used to effectively search for the cutting plane so as to find the optimal solution faster. To this end, AI0 divides the integer programming problem into new restricted partitions through an algorithm, and enumerates all possible variables by constructing a tree model.

It should be noted that the above algorithm only detects the branches in the tree model that are expected to produce the optimal or nearly optimal ones. New linear constraints can be processed using the simplex method, and the above process can be repeated.

As an example, the process of using a dynamic programming algorithm to solve the integer programming problem of the optimization model of an example of the present disclosure is described here. The process may include the following steps. The first step is to initialize the dynamic programming problem, including: initializing the assignment strategy (for example, null), initializing the integer programming problem (for example, null), and initializing the energy consumption value (for example, negative infinity). The second step is to set Zₖ and yᵢₖ to initial values (for example, zero value). The third step is to determine the dynamic node set of the integer programming problem. The fourth step is to perform iterative programming until the traversal of all integer programming problems is completed, so as to find the optimal solution.

The fourth step may include the following sub-steps. Step 1 is to arbitrarily select an integer programming problem from the dynamic node set; step 2 is to relax the selected integer programming problem to obtain the solution of the relaxed version of the programming problem; step 3 is that if the obtained solution is not feasible, return to step 1; step 4 is that if the obtained solution is feasible, the assignment strategy corresponding to this solution can be obtained, and a target function value can be obtained; step 5 is that since the energy consumption value is usually set to a negative value, if the target function value is less than or equal to the current optimal energy consumption value, return to step 1; step 6 is that if the target function value is greater than the current optimal energy consumption value, the target function value is assigned as the new optimal energy consumption value, the assignment strategy corresponding to the target function value is taken as the new optimal assignment strategy, and return to step 1; step 7 is to search for the cutting plane determined by the assignment strategy; step 8 is that if the cutting plane is not null, it means that there is a decimal solution, then let the union of the cutting plane and the current cutting plane set be the new cutting plane set, and return to step 2; step 9 is that if the cutting plane is null, it means that there is no decimal solution, the branch and bound method is used to divide the integer programming problem into a new integer programming problem with a restricted feasible area, the integer programming problem is added to the dynamic node set of the integer programming problem, and return to step 3.

FIG. 2 is a schematic flowchart of a method for providing an AI service according to an example of the present disclosure. As shown in FIG. 2, the method may include S201 to S208. In an example shown in FIG. 2, AI0 is used as a first core network device, AMF is used as a second core network device, AI1 to AI3 are used as third core network devices, and the UE is used as a terminal for illustration. It should be noted that in 5G and later versions of communication network, the first core network device, the second core network device, the third core network device and the terminal may also be other functional entities or devices, which are not limited here.

In the S201, the UE sends a request message to the AMF.

The request message (also referred to as a second request message) is configured to request an AI service (also referred to as a first AI service).

It can be understood that in an example, the request message can be configured to request the AMF to establish the AI service. For example, the request message can be an AI service establishment request message.

In order to establish the AI service, the request message may carry relevant information of the AI service. In an example of the present disclosure, the request message may carry at least one of the following information: a deep neural network (DNN), AI service identification information, and AI service type information. The DNN may be a neural network configured to participate in the AI service. The AI service identification information may be configured to identify the AI service. The AI service type information may be configured to identify the type of the AI service and may be used as a basis for determining the assignment strategy of the AI service. For example, the type of the AI service here may include an image service, an audio service, a video service, a language service, and the like. In an example, the request message may carry the AI service type information. In an example, the request message may carry the AI service type information and the AI service identification information. In an example, the request message may carry the AI service type information and the DNN. In an example, the request message may carry the AI service type information, the AI service identification information, and the DNN.

It should be noted that the UE can send the request message to the AMF via a radio access network (RAN). Specifically, the UE can send the request message to the gNB in the RAN via the Uu interface, and then the gNB forwards the request message to the AMF via the N2 interface.

In actual applications, before the UE sends the request message to the AMF, the UE has already accessed the core network through the gNB. In addition, a terminal program may be run on the UE, and the UE sends the request message under the control of the terminal program. For example, the terminal program may be a program dedicated to providing the AI service to the user of the terminal. In this case, the main function of the terminal program may be to request the AI service from the core network device and obtain the result information of the AI service, and then provide the result information to the user. For another example, the main function of the terminal program may be to implement a specific function. In the process of implementing the specific function, the support of the AI service may be required. In this case, the terminal program may request the AI service and obtain the result information in the process of implementing the specific function, and then apply the result information to the implementation of the specific function.

In the S202, the AMF sends a request message to AI0.

The request message (also referred to as a first request message) is configured to request AI0 to provide the AI service.

It can be understood that after receiving the request message from the UE in the S201, the AMF, as a manager of the AI service, sends the request message to AI0 according to this request message. In an example of the present disclosure, the request message sent by the AMF to AI0 may carry the relevant information of the AI service. For example, the request message sent by the AMF may be an AI0 context creation request message.

It should be noted that the relevant information carried in the request message sent by the AMF may include at least one of the following information: a deep neural network (DNN), AI service identification information, and AI service type information. The DNN and the AI service identification information are the same as the DNN and the AI service identification information in the S201.

However, the AI service type information carried in the request message sent by the AMF may be different from the AI service type information in the S201. For example, a type of the AI service here may include personalized recommendation, machine translation, etc. In an example of the present disclosure, the AMF may determine the AI service type information in the S202 based on the AI service type information in the S201.

In actual applications, the personalized recommendation and the machine translation have a wide range of meanings. The personalized recommendation can be to determine product recommendation information based on historical data. For example, in a business recommendation scenario, the historical data may include at least browsing data, evaluation data, purchase data, consultation data, etc., and the recommendation information may be product information. For another example, in a library borrowing scenario, the historical data may be user's borrowing data, and the recommendation information may be book information. The machine translation may be to translate an input language into another language using technologies such as natural language processing. For example, in the case of inputting a Chinese voice, the Chinese voice can be translated into a voice or text in a target language. For another example, in the case of browsing a document or a web page, a text in English or other languages can be translated into Chinese.

In an example, the request message may carry the AI service type information. In an example, the request message may carry the AI service type information and the AI service identification information. In an example, the request message may carry the AI service type information and the DNN. In an example, the request message may carry the AI service type information, the AI service identification information, and the DNN.

In addition, in an example, the request message sent by the AMF may also carry at least one of the following information: user information, an access type, and a generic public subscription identifier (GPSI). The user information may be information of the user of the terminal. The access type may be configured to indicate a type of the UE accessing the core network.

In the S203, AI0 assigns the AI service.

AI0 is used to assign the AI service among AI1, AI2, and AI3, and each of AI1, AI2, and AI3 has its own AI function and AI capability. It can be understood that the AI functions and/or the AI capabilities implemented by any two of AI1, AI2, and AI3 may be the same, different, or partially the same. In addition, different AI functions and/or AI capabilities in AI1, AI2, and AI3 may be implemented by different AI algorithms or by the same AI algorithm. It should be noted that in this example, the number of AI processing functions being 3 is taken as an example for illustration. However, in actual applications, the AI processing function may have any number according to actual conditions or requirements.

It can be understood that in order to implement the assignment of the AI service among AI1, AI2, and AI3, AI0 may determine the assignment strategy, which is configured to indicate that the AI service is assigned to at least one of AI, AI2, and AI3.

In an example of the present disclosure, AI0 may determine the assignment strategy in the following manner. Firstly, AI0 may obtain the device information of each of AI1, AI2, and AI3. Secondly, AI0 may determine the assignment strategy based on the AI service type information and the device information of AI1, AI2, and AI3.

In an example of the present disclosure, the device information of AI1, AI2, and AI3 may be received by AI0 from AI1, AI2, and AI3. In an example, AI1, AI2, and AI3 may actively send the device information to AI0 periodically or intermittently. In an example, AI0 may send a device information request to one or more of AI1, AI2, and AI3, and receive the device information which is returned in response to the device information request.

In an example of the present disclosure, in order to determine the assignment strategy, AI0 may first divide the AI service into at least one task according to the AI service type information; and then, AI0 may determine the assignment strategy of the at least one task based on the optimization model and according to the device information.

It can be understood that the device information may include a delay value and an energy consumption value. The delay value may include a transmission delay and a processing time. The transmission delay may include an uplink delay and/or a downlink delay. The energy consumption value may include a transmission energy consumption and a calculation energy consumption. The transmission energy consumption may include an uplink energy consumption and/or a downlink energy consumption. In addition, the optimization model may be constructed based on the device information of AI1, AI2, and AI3 and the task of the AI service. The input of the optimization model is an indication value of the assignment of the task on AI1, AI2, and AI3, the output is the total energy consumption value, and the constraint condition is a constraint on the input. In order to determine the assignment strategy, AI0 can find the optimal solution of the optimization model. In actual applications, determining the assignment strategy based on the optimization model can be implemented through the dynamic programming. It should be noted that for the specific construction process of the optimization model and the process of finding the optimal solution by the dynamic programming, reference may be made to the description in the previous text, which will not be repeated here.

In an example of the present disclosure, AI0 can divide the AI service into two tasks, namely, task M1 and task M2, according to the AI service type information. According to the device information of AI, AI2, and AI3 and based on the optimization model, the assignment strategy can be determined as follows: M1 is assigned to AI1, and M2 is assigned to AI3. Therefore, in this example, AI1, AI2, and AI3 are an example of one or more third core network devices described in the present disclosure, AI1 and AI3 are an example of at least one third core network device described in the present disclosure, and tasks M1 and M2 are an example of at least one task described in the present disclosure.

After determining the assignment strategy, AI0 can assign the AI service among AI1, AI2, and AI3. Specifically, AI0 can issue tasks to AI processing functions assigned with tasks among AI1, AI2, and AI3, respectively. In an example of the present disclosure, since M1 is assigned to AI1 and M2 is assigned to AI3, AI0 can issue task M1 to AI1 and task M2 to AI3.

Specifically, in an example of the present disclosure, AI0 may send a task assignment message to AI processing functions assigned with tasks among AI1, AI2, and AI3. For example, AI0 may send a task assignment message to AI1, and the task assignment message indicates that task M1 is assigned; AI0 may send a task assignment message to AI3, and the task assignment message indicates that task M2 is assigned.

It should be noted that if the received request message carries the DNN, the DNN can be used together with the AI service type information to divide the AI service, or it can be associated with one or more tasks of the AI service. In the former case, the DNN can be used to determine the type, time complexity, space complexity, etc. of the algorithm of the AI service. In the latter case, AI0 can send the DNN to the corresponding AI processing function when sending the task. For example, when the DNN is associated with M2, AI0 can also send the DNN to AI3 in the process of sending task M2.

Alternatively, before AI0 assigns the AI service, the AI processing function should have been registered with AI0, and AI0 should have obtained the device information of the AI processing function. In an example of the present disclosure, AI0 can receive a registration request message from AI1, AI2, and AI3, and complete the registration of AI1, AI2, and AI3 in response to the registration request message. In an example of the present disclosure, AI1, AI2, and AI3 can send the device information to AI0 through the registration request message.

In the S204, AI1 and AI3 perform task processing.

AI1 can process the assigned task M1, and AI3 can process the assigned task M2.

It can be understood that the processing performed by AI1 on M1 and the processing performed by AI3 on M2 are independent of each other.

It should be noted that within the core network, UDR and the unstructured data storage network function (UDSF) are used to store and provide structured data and unstructured data, respectively. AI1 and AI3 may need to obtain data from UDR and/or UDSF when processing. The data may be stored in UDR and/or UDSF during the registration process of the UE and the process of the UE making the AI service request. In an example, when the AI service includes image processing, the data may include an image to be processed. In an example, when the AI service includes voice translation, the data may include a voice to be processed. In an example, when the AI service includes the text translation, the data may include a text to be translated. In an example, when the AI service includes the AI recommendation, the data may include browsing data, evaluation data, purchase data, and/or consultation data, etc.

In the S205, AI0 obtains a processing result.

After AI1 and AI3 respectively process M1 and M2 in the S204, AI1 and AI3 send processing results to AI0.

It can be understood that after AI1 processes M1 and obtains the processing result, it can send the processing result to AI0; after AI3 processes M2 and obtains the processing result, it can send the processing result to AI0. AI0 obtaining the processing result of AI1 is independent of AI0 obtaining the processing result of AI3.

Specifically, in an example of the present disclosure, AI0 can receive task feedback messages from AI processing functions assigned with tasks among AI1, AI2, and AI3. For example, AI0 can receive a task feedback message from AI1, which carries the processing result of M1, and AI0 can receive a task feedback message from AI3, which carries the processing result of M2.

In S206, AI0 sends a response message to AMF.

The response message (also called a first response message) carries the result information of the AI service obtained based on the processing result.

It can be understood that after obtaining the processing results of AI1 and AI3 for M1 and M2 in the S205, AI0 first obtains the result information of the AI service based on the processing result. In an example, the result information may be obtained by splicing the processing results of AI1 and AI3. In an embodiment, the result information may be obtained by calculating the processing results of AI1 and AI3. It should be noted that in the process of obtaining the result information based on the processing result, AI0 may perform structured processing on the processing result.

In the S207, AMF sends a response message to the UE.

The response message (also referred to as a second response message) carries the result information.

It should be noted that the AMF can send the response message to the UE via the RAN. Specifically, the AMF can send the request message to the gNB in the RAN via the N2 interface; then, the gNB can forward the request message to the UE via the Uu interface. In an example, the gNB can transparently transmit the response message from the AMF to the UE.

In the S208, the UE sends a feedback message to AI0 via the AMF.

The feedback message carries feedback information of the UE for the result information.

It can be understood that after obtaining the result information in the S207, the UE may receive a user input and generate the feedback information according to the user input, or may generate the feedback information by itself.

In an example of the present disclosure, the feedback information may be configured to indicate whether the result information meets a preset specification. For example, the preset specification may include accuracy, hit rate, etc. If the result information meets the preset specification, the feedback information may indicate that the result information is satisfactory; and if the result information does not meet the preset specification, the feedback information may indicate that the result information is unsatisfactory. The feedback information may include one or more bits. Different bit values may be used to indicate different meanings of the feedback information.

It can be understood that the S208 is an optional step. In an example of the present disclosure, the UE may not send the feedback message.

It should be noted that after S207 or S208, the AI service process ends, and AMF and AI0 can deregister the AI service respectively. In an example, the UE can send a deregistration message to the AMF, and the AMF can also send a deregistration message to AI0. The deregistration message may carry AI service identification information. After receiving the deregistration message, AMF and AI0 can deregister the AI service corresponding to the deregistration message. In an example, AMF and AI0 can deregister the AI service by themselves after completing the above process.

So far, the process of the method for providing the AI service ends.

In example of the present disclosure, based on a hierarchical architecture of an AI network composed of AI functions, by determining the assignment scheme of the AI service among respective AI functions, it is possible to reasonably assign resources for the AI service, thereby providing the flexible AI service.

Furthermore, the present disclosure can further optimize the resource assignment of the AI service by setting delay and task scheduling constraint conditions and determining an AI service assignment scheme that meets the constraint conditions and has the minimized energy consumption, thereby providing the efficient AI service.

Based on the same inventive concept, examples of the present disclosure further provide a method for providing an AI service.

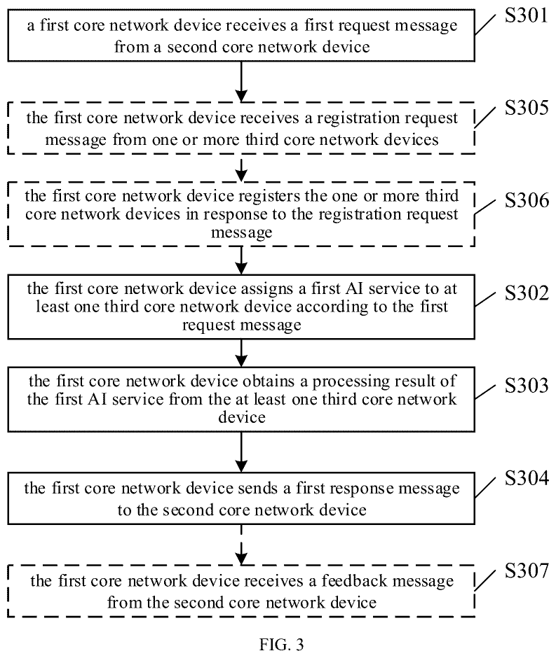

FIG. 3 is a schematic flowchart of a method for providing an AI service according to an example of the present disclosure. Referring to FIG. 3, an example of the present disclosure provides a method for providing an AI service, which is applied to a first core network device. The method includes S301 to S304.

In the S301, the first core network device receives a first request message from a second core network device.

The first request message is configured to request the first core network device to provide a first AI service.

In the S302, the first core network device assigns the first AI service to at least one third core network device according to the first request message.

In the S303, the first core network device obtains a processing result of the first AI service from the at least one third core network device.

In the S304, the first core network device sends a first response message to the second core network device.

The first response message carries result information of the first AI service obtained based on the processing result.

In some implementations, the first request message may carry first AI service type information for the first AI service. The operation S302 of the first core network device assigning the first AI service to the at least one third core network device according to the first request message may include: the first core network device obtains device information of one or more third core network devices, and the one or more third core network devices include the at least one third core network device; the first core network device determines an assignment strategy based on the first AI service type information and the device information, and the assignment strategy is configured to indicate that the first AI service is assigned to the at least one third core network device among the one or more third core network devices; and the first core network device assigns the first AI service to the at least one third core network device based on the assignment strategy.

In some implementations, the operation of the first core network device obtaining the device information of the one or more third core network devices may include: the first core network device receives device information from the one or more third core network devices.

In some implementations, the operation of determining the assignment strategy by the first core network device based on the first AI service type information and the device information may include: the first core network device divides the first AI service into at least one task according to the first AI service type information; and the first core network device determines the assignment strategy of the at least one task based on the optimization model and according to the device information.

In some implementations, the device information may include an energy consumption value and a delay value. The optimization model may include a constraint condition, an input, and an output. The constraint condition may include a constraint on the input and/or the output. The input may include an indication value that each of the at least one task is assigned to each of the one or more third core network devices. The output may be a total energy consumption value.

In some implementations, the constraint condition may include: the sum of delay values of the at least one third core network device is less than or equal to a delay threshold. The delay value may include a processing delay and a transmission delay.

In some implementations, the operation of the first core network device determining the assignment strategy of the at least one task based on the optimization model and according to the device information may include: the first core network device inputs the indication value into the optimization model to obtain the total energy consumption value output by the optimization model; and the first core network device determines the assignment strategy corresponding to the total energy consumption value.

In some implementations, before the operation S302 of the first core network device assigning the first AI service to the at least one third core network device among the one or more third core network devices according to the first request message, the method may further include: in S305, the first core network device receives a registration request message from the one or more third core network devices, and the one or more third core network devices include the at least one third core network device; and in S306, the first core network device registers the one or more third core network devices in response to the registration request message.

In some implementations, the registration request message may carry the device information of the one or more third core network devices.

In some implementations, the method may further include: in S307, the first core network device receives a feedback message from the second core network device, and the feedback message carries feedback information of the terminal for the result information, and the feedback information is configured to indicate whether the result information meets a preset specification.

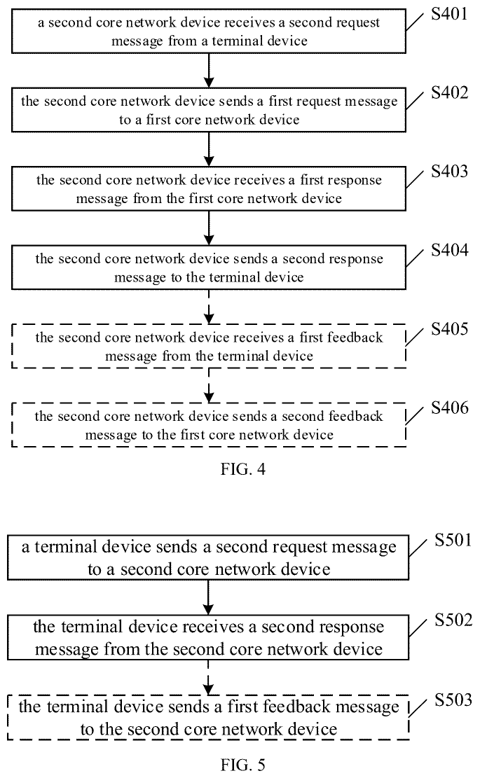

FIG. 4 is a schematic flowchart of a method for providing an AI service according to an example of the present disclosure. Referring to FIG. 4, an example of the present disclosure provides a method for providing an AI service, which is applied to a second core network device. The method includes S401 to S404.

In the S401, the second core network device receives a second request message from a terminal.

The second request message is configured to request a first AI service.

In the S402, the second core network device sends a first request message to a first core network device.

The first request message is configured to request the first core network device to provide the first AI service.

In the S403, the second core network device receives a first response message from the first core network device.

The first response message carries result information of the first AI service.

In the S404, the second core network device sends a second response message to the terminal.

The second response message carries the result information of the first AI service.

In some implementations, the first request message may carry first AI service type information for the first AI service, and the first AI service type information is configured to determine an assignment strategy of the first AI service.

In some implementations, the method may further include: in S405, the second core network device receives a first feedback message from the terminal; and in S406, the second core network device sends a second feedback message to the first core network device. Both the first feedback message and the second feedback message carry feedback information of the terminal for the result information, and the feedback information is configured to indicate whether the result information meets a preset specification.

FIG. 5 is a schematic flowchart of a method for providing an AI service according to an example of the present disclosure. Referring to FIG. 5, an example of the present disclosure provides a method for providing an AI service, which is applied to a terminal. The method includes S501 and S502.

In the S501, the terminal sends a second request message to a second core network device.

The second request message is configured to request a first AI service.

In the S502, the terminal receives a second response message from the second core network device.

The second response message carries result information of the first AI service.

In some implementations, the method further includes: in S503, the terminal sends a first feedback message to the second core network device, and the first feedback message carries feedback information of the terminal for the result information, and the feedback information is configured to indicate whether the result information meets a preset specification.

Based on the same inventive concept, examples of the present disclosure further provide an apparatus for providing an AI service.

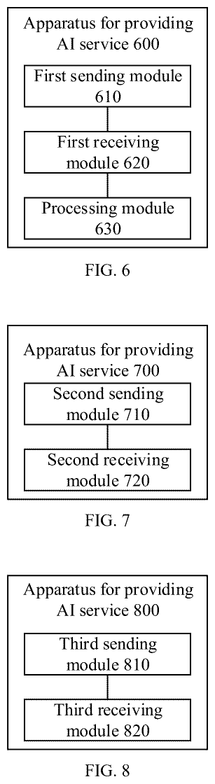

FIG. 6 is a schematic structural diagram of an apparatus for providing an AI service according to an example of the present disclosure. Referring to FIG. 6, the apparatus 600 may include: a first sending module 610, a first receiving module 620, and a processing module 630. The first receiving module 620 is configured to receive a first request message from a second core network device, and the first request message is configured to request a first core network device to provide a first AI service. The processing module 630 is configured to assign the first AI service to at least one third core network device according to the first request message; and obtain a processing result of the first AI service from the at least one third core network device. The first sending module 610 is configured to send a first response message to the second core network device, and the first response message carries result information of the first AI service obtained based on the processing result.

In some implementations, the first request message may carry first AI service type information for the first AI service. The processing module 630 may be configured to: obtain device information of one or more third core network devices, and the one or more third core network devices include the at least one third core network device; determine an assignment strategy based on the first AI service type information and the device information, and the assignment strategy is configured to indicate that the first AI service is assigned to the at least one third core network device among the one or more third core network devices; and assign the first AI service to the at least one third core network device based on the assignment strategy.

In some implementations, the processing module 630 may be configured to: receive device information from the one or more third core network devices.

In some implementations, the processing module 630 may be configured to: divide the first AI service into at least one task according to the first AI service type information; and determine the assignment strategy of the at least one task based on an optimization model and according to the device information.

In some implementations, the device information may include an energy consumption value and a delay value. The optimization model may include a constraint condition, an input and an output. The constraint condition may include a constraint on the input and/or the output. The input may include an indication value of each of the at least one task being assigned to each of the one or more third core network devices. The output may be a total energy consumption value.

In some implementations, the constraint condition may include a sum of delay values of the at least one third core network device being less than or equal to a delay threshold. The delay value may include a processing delay and a transmission delay.

In some implementations, the processing module 630 may be configured to: input the indication value into the optimization model to obtain the total energy consumption value which is output by the optimization model; and determine the assignment strategy corresponding to the total energy consumption value.

In some implementations, the first receiving module 620 may further be configured to: receive a registration request message from one or more third core network devices, and the one or more third core network devices include the at least one third core network device. The processing module may further be configured to: register the one or more third core network devices in response to the registration request message.

In some implementations, the registration request message may carry device information of the one or more third core network devices.

In some implementations, the first receiving module 620 may further be configured to: receive a feedback message from the second core network device, and the feedback message carries feedback information of a terminal for the result information, and the feedback information is configured to indicate whether the result information meets a preset specification.

FIG. 7 is a schematic structural diagram of an apparatus for providing an AI service according to an example of the present disclosure. Referring to FIG. 7, the apparatus 700 may include: a second sending module 710 and a second receiving module 720. The second receiving module 720 is configured to receive a second request message from a terminal, and the second request message is configured to request a first AI service. The second sending module 710 is configured to send a first request message to a first core network device, and the first request message is configured to request the first core network device to provide the first AI service. The second receiving module 720 is further configured to receive a first response message from the first core network device, and the first response message carries result information of the first AI service. The second sending module 710 is further configured to send a second response message to the terminal, and the second response message carries the result information of the first AI service.

In some implementations, the first request message may carry first AI service type information for the first AI service, and the first AI service type information is configured to determine an assignment strategy of the first AI service.

In some implementations, the second receiving module 720 may further be configured to receive a first feedback message from the terminal. The second sending module 710 may further be configured to: send a second feedback message to the first core network device. The first feedback message and the second feedback message both carry feedback information of the terminal for the result information, and the feedback information is configured to indicate whether the result information meets a preset specification.

FIG. 8 is a schematic structural diagram of an apparatus for providing an AI service according to an example of the present disclosure. Referring to FIG. 8, the apparatus 800 may include: a third sending module 810 and a third receiving module 820. The third sending module 810 is configured to send a second request message to a second core network device, and the second request message is configured to request a first AI service. The third receiving module 820 is configured to receive a second response message from the second core network device, and the second response message carries result information of the first AI service.

In some implementations, the method may further include: sending a first feedback message to the second core network device, and the first feedback message carries feedback information of the terminal for the result information, and the feedback information is configured to indicate whether the result information meets a preset specification.

According to a sixth aspect of the present disclosure, there is provided a core network device, including: a memory, configured to store computer executable instructions; and a processor, connected to the memory and configured to execute the computer executable instructions stored on the memory to implement the method according to any one of the first aspect and the second aspect and their implantations.

According to a seventh aspect of the present disclosure, there is provided a terminal, including a memory, configured to store computer executable instructions; and a processor, connected to the memory and configured to execute the computer executable instructions stored on the memory to implement the method according to any one of the third aspect and its implantations.

According to an eighth aspect of the present disclosure, there is provided a computer readable storage medium having computer executable instructions stored thereon; and the computer executable instructions, when executed by a processor in a computer, enable the method according to any one of the first aspect to the third aspect and their implantations to be implemented.

According to a ninth aspect of the present disclosure, there is provided a computer program or a computer program product, and the computer program product, when executed on a computer, causes the computer to implement the method according to any one of the first aspect to the third aspect and their implantations.

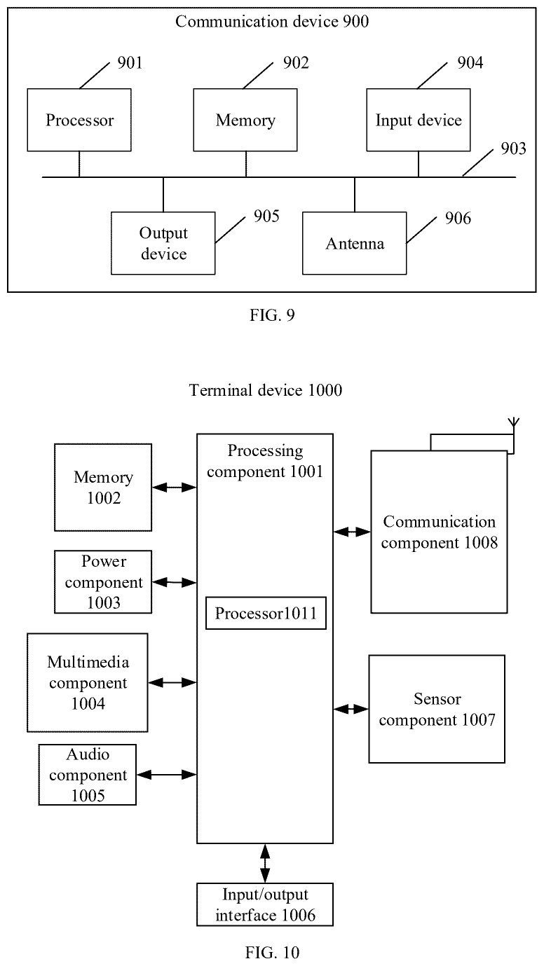

Based on the same inventive concept, an example of the present disclosure provides a communication device. The communication device may be a terminal or a core network device described in one or more of the above examples. FIG. 9 is schematic structural diagram of a communication device according to an example of the present disclosure. Referring to FIG. 9, a communication device 900 uses general computer hardware, including a processor 901, a memory 902, a bus 903, an input device 904, and an output device 905.

In some implementations, the memory 902 may include computer storage media in the form of volatile and/or non-volatile memory, such as read-only memory and/or random access memory. The memory 902 may store an operating system, application programs, other program modules, executable code, program data, user data, etc.

The input device 904 can be used to input commands and information to the communication device, such as a keyboard or a pointing device, such as a mouse, trackball, touch pad, microphone, joystick, game pad, satellite TV antenna, scanner or similar device. These input devices can be connected to processor 901 via bus 903.

The output device 905 can be used for outputting information from the communication device. In addition to the monitor, the output device 905 can also be other peripheral output devices, such as speakers and/or printing devices. These output devices can also be connected to the processor 901 through the bus 903.

The communication device may be connected to a network, such as a local area network (LAN), via the antenna 906. In a networked environment, the computer-executable instructions stored in the control device may be stored in a remote storage device, rather than being limited to local storage.

When the processor 901 in the communication device executes the executable code or application stored in the memory 902, the communication device executes the method for providing the AI service of the terminal or core network device in the above examples. The specific execution process refers to the above examples and will not be repeated here.

In addition, the memory 902 stores computer-executable instructions for implementing the functions of the functional modules in FIG. 6 to FIG. 8. The functions/implementation processes of the functional modules in FIG. 6 to FIG. 8 can be implemented by the processor 901 in FIG. 9 calling the computer-executable instructions stored in the memory 902. For specific implementation processes and functions, refer to the above-mentioned related examples.

Based on the same inventive concept, examples of the present disclosure provide a terminal, which is consistent with the terminal in one or more of the above examples. In some examples, the terminal can be a mobile phone, a computer, a digital broadcast terminal, a message transceiver device, a game console, a tablet device, a medical device, a fitness device, a personal digital assistant, etc.

FIG. 10 is a schematic structural diagram of a terminal according to an example of the present disclosure. As shown in FIG. 10, the terminal 1000 may include one or more of the following components: a processing component 1001, a memory 1002, a power component 1003, a multimedia component 1004, an audio component 1005, an input/output (I/O) interface 1006, a sensor component 1007, and a communication component 1008.

The processing component 1001 typically controls overall operations of the terminal 1000, such as the operations associated with display, telephone calls, data communications, camera operations, and recording operations. The processing component 1001 may include one or more processors 1011 to execute instructions to complete all or part of the steps in the above described methods. Moreover, the processing component 1001 may include one or more modules which facilitate the interaction between the processing component 1001 and other components. For instance, the processing component 1001 may include a multimedia module to facilitate the interaction between the multimedia component 1004 and the processing component 1001.

The memory 1002 is configured to store various types of data to support the operation of the terminal 1000. Examples of such data include instructions for any applications or methods operated on the terminal 1000, contact data, phonebook data, messages, pictures, video, etc. The memory 1002 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1003 provides power to various components of the terminal 1000. The power component 1003 may include a power management system, one or more power sources, and any other components associated with the generation, management, and distribution of power in the terminal 1000.

The multimedia component 1004 includes a screen providing an output interface between the terminal 1000 and the user. In some examples, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some examples, the multimedia component 1004 includes a front camera and/or a rear camera. The front camera and the rear camera may receive an external multimedia datum while the terminal 1000 is in an operation mode, such as a photographing mode or a video mode. Each of the front camera and the rear camera may be a fixed optical lens system or have focus and optical zoom capability.

The audio component 1005 is configured to output and/or input audio signals. For example, the audio component 1005 includes a microphone (MIC) configured to receive an external audio signal when the terminal 1000 is in an operation mode, such as a call mode, a recording mode, and a voice recognition mode. The received audio signal may be further stored in the memory 1002 or transmitted via the communication component 1008. In some examples, the audio component 1005 further includes a speaker to output audio signals.

The I/O interface 1006 provides an interface between the processing component 1001 and peripheral interface modules, such as a keyboard, a click wheel, buttons, and the like. The buttons may include, but are not limited to, a home button, a volume button, a starting button, and a locking button.

The sensor component 1007 includes one or more sensors to provide state assessments of various aspects of the terminal 1000. For instance, the sensor component 1007 may detect an open/closed state of the terminal 1000, relative positioning of components, e.g., the display and the keypad, of the terminal 1000, a change in position of the terminal 1000 or a component of the terminal 1000, a presence or absence of user contact with the terminal 1000, an orientation or an acceleration/deceleration of the terminal 1000, and a change in temperature of the terminal 1000. The sensor component 1007 may include a proximity sensor configured to detect the presence of nearby objects without any physical contact. The sensor component 1007 may also include a light sensor, such as a CMOS or CCD image sensor, for use in imaging applications. In some examples, the sensor component 1007 may also include an accelerometer sensor, a gyroscope sensor, a magnetic sensor, a pressure sensor, or a temperature sensor.

The communication component 1008 is configured to facilitate communication, wired or wirelessly, between the terminal 1000 and other devices. The terminal 1000 may access a wireless network based on a communication standard, such as Wi-Fi, 2G, 3G, 4G or 5G, or a combination thereof. In an example, the communication component 1008 receives a broadcast signal or broadcast associated information from an external broadcast management system via a broadcast channel. In an example, the communication component 1008 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

According to an example of the present disclosure, the terminal 1000 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

Based on the same inventive concept, an example of the present disclosure provides a network device, which is consistent with the network device in one or more of the above examples.

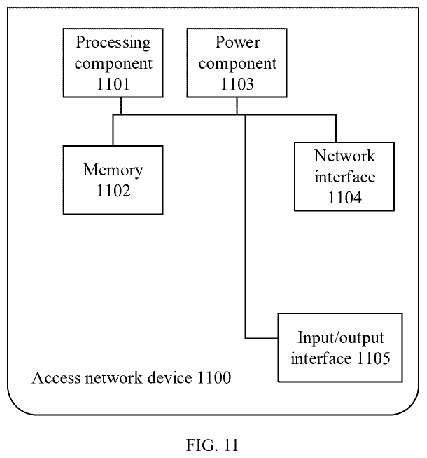

FIG. 11 is a schematic structural diagram of a network device according to an example of the present disclosure. The network device may be an access network device or a core network device. Referring to FIG. 11, the network device 1100 includes a processing component 1101, which further includes one or more processors and a memory resource represented by a memory 1102 for storing instructions executable by the processing component 1101, such as an application program. The application program stored in the memory 1102 may include one or more modules, each corresponding to a set of instructions. In addition, the processing component 1101 is configured to execute the instructions to execute the aforementioned any method applied on the network device.

The network device 1100 may further include: a power component 1103 configured to perform power management of the network device 1100, a wired or wireless network interface 1104 configured to connect the network device 1100 to the network, and an input/output (I/O) interface 1105. The network device 1100 may operate an operating system stored in the memory 1102, such as Windows Server™, Mac OS X™, Unix™, Linux™, FreeBSD™, or the like.

Based on the same inventive concept, an example of the present disclosure further provides a computer-readable storage medium, in which instructions are stored; when the instructions are executed on a computer, the instructions are used to execute the method described in one or more of the above examples.

Based on the same inventive concept, the examples of the present disclosure further provide a computer program or a computer program product. When the computer program product is executed on a computer, the computer implements the method described in one or more of the above examples.

Other implementations of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and examples are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for providing an artificial intelligence (AI) service, comprising:
receiving, by a first core network device, a first request message from a second core network device, wherein the first request message is configured to request the first core network device to provide a first AI service;
assigning, by the first core network device, the first AI service to at least one third core network device according to the first request message;
obtaining, by the first core network device, a processing result of the first AI service from the at least one third core network device; and
sending, by the first core network device, a first response message to the second core network device, wherein the first response message carries result information of the first AI service obtained based on the processing result.

2. The method according to claim 1, wherein first AI service type information for the first AI service is carried in the first request message;
wherein assigning, by the first core network device, the first AI service to the at least one third core network device according to the first request message comprises:
obtaining, by the first core network device, device information of one or more third core network devices, wherein the one or more third core network devices comprise the at least one third core network device;
determining, by the first core network device, an assignment strategy based on the first AI service type information and the device information, wherein the assignment strategy is configured to indicate that the first AI service is assigned to the at least one third core network device among the one or more third core network devices; and
assigning, by the first core network device, the first AI service to the at least one third core network device based on the assignment strategy.

3. The method according to claim 2, wherein obtaining, by the first core network device, the device information of the one or more third core network devices comprises:
receiving, by the first core network device, the device information from the one or more third core network devices.

4. The method according to claim 2, wherein determining, by the first core network device, the assignment strategy based on the first AI service type information and the device information comprises:
dividing, by the first core network device, the first AI service into at least one task according to the first AI service type information; and
determining, by the first core network device, the assignment strategy of the at least one task based on an optimization model and the device information.

5. The method according to claim 4, wherein the device information comprises an energy consumption value and a delay value; the optimization model comprises a constraint condition, an input and an output, the constraint condition comprises a constraint on at least one of the input or the output, the input comprises an indication value of each of the at least one task being assigned to each of the one or more third core network devices, and the output is a total energy consumption value.

6. The method according to claim 5, wherein the constraint condition comprises a sum of delay values of the at least one third core network device being less than or equal to a delay threshold; and
wherein the delay value comprises a processing delay and a transmission delay.

7. The method according to claim 5, wherein determining, by the first core network device, the assignment strategy of the at least one task based on the optimization model and the device information comprises:
inputting, by the first core network device, the indication value into the optimization model to obtain the total energy consumption value which is output by the optimization model; and
determining, by the first core network device, the assignment strategy corresponding to the total energy consumption value.

8. The method according to claim 1, wherein before assigning, by the first core network device, the first AI service to the at least one third core network device among the one or more third core network devices according to the first request message, the method further comprises:
receiving, by the first core network device, a registration request message from one or more third core network devices, wherein the one or more third core network devices comprise the at least one third core network device; and
performing, by the first core network device, registration on the one or more third core network devices in response to the registration request message.

9. The method according to claim 8, wherein device information of the one or more third core network devices is carried in the registration request message.

10. The method according to claim 1, wherein the method further comprises:
receiving, by the first core network device, a feedback message from the second core network device, wherein feedback information of a terminal for the result information is carried in the feedback message, and the feedback information is configured to indicate whether the result information meets a preset specification.

11. A method for providing an artificial intelligence (AI) service, comprising:
receiving, by a second core network device, a second request message from a terminal, wherein the second request message is configured to request a first AI service;
sending, by the second core network device, a first request message to a first core network device, wherein the first request message is configured to request the first core network device to provide the first AI service;
receiving, by the second core network device, a first response message from the first core network device, wherein the first response message carries result information of the first AI service; and
sending, by the second core network device, a second response message to the terminal, wherein the second response message carries the result information of the first AI service.

12. The method according to claim 11, wherein first AI service type information for the first AI service is carried in the first request message, and the first AI service type information is configured to determine an assignment strategy of the first AI service.

13. The method according to claim 11, wherein the method further comprises:
receiving, by the second core network device, a first feedback message from the terminal; and
sending, by the second core network device, a second feedback message to the first core network device;
wherein feedback information of the terminal for the result information is carried both in the first feedback message and the second feedback message, and the feedback information is configured to indicate whether the result information meets a preset specification.

14. A method for providing an artificial intelligence (AI) service, comprising:
sending, by a terminal, a second request message to a second core network device, wherein the second request message is configured to request a first AI service; and
receiving, by the terminal, a second response message from the second core network device, wherein result information of the first AI service is carried in the second response message.

15. The method according to claim 14, wherein the method further comprises:
sending, by the terminal, a first feedback message to the second core network device, wherein feedback information of the terminal for the result information is carried in the first feedback message, and the feedback information is configured to indicate whether the result information meets a preset specification.

16-18. (canceled)

19. A first core network device, comprising: a memory; and a processor connected to the memory and configured to execute computer executable instructions stored in the memory to implement the method according to claim 1.

20. A terminal, comprising: a memory; and a processor connected to the memory and configured to execute computer executable instructions stored in the memory to implement the method according to claim 14.

21. A non-transitory computer storage medium having computer executable instructions stored thereon, a processing module, wherein the computer executable instructions, when executed by a processor, enable the method according to claim 1 to be implemented.

22. A second core network device, comprising: a memory; and a processor connected to the memory and configured to execute computer executable instructions stored in the memory to implement the method according to claim 11.

23. A non-transitory computer storage medium having computer executable instructions stored thereon, a processing module, wherein the computer executable instructions, when executed by a processor, enable the method according to claim 11 to be implemented.
